(19) United States
(12) Patent Application Publication
(10) Pub. No.: US 2009/0012211 A1
(43) Pub. Date: Jan. 8, 2009

(54) Novel biodegradable nanocomposites

(76) Inventor: David Abecassis, Huntington, NY (US)

Correspondence Address: Thomas A. O'Rourke;Bodner & O'Rourke, 425 Broadhollow Road, Melville, NY, 11747, US

(21) Appl. No.: 11/824,773

(22) Filed: Jul. 2, 2007

(51) Int. Cl. C08K 13/02

(52) U.S. Cl. 523/128; 523/124

(57) ABSTRACT

Biodegradable compositions of clay, diphosphates and biodegradable polymers are described. The diphosphates may be resorcinol diphosphate or bisphenol diphosphate. The biodegradable polymer may be a cellulose.

### FIELD OF THE INVENTION

The present invention is directed to blends of biodegradable thermoplastics with nanofiller additives to make biodegradable nanocomposites useful in a variety of applications when biodegradable properties are important.

### BACKGROUND OF THE INVENTION

Biodegradation is a term applied to the mineralization of complex compounds by enzymes and biochemical reactions, into carbon dioxide, water, biomass and/or soil humic matter. In nature, this allows for a sustainable ecosystem since nutrients such as nitrogen and phosphorous can be recycled. Biodegradation allows for water purification in both fresh and saltwater by removing suspended solids and mineralizing dead biomass that would otherwise foul oceans, lakes, and rivers.

Biodegradation was first used during the middle ages to increase crop productivity from the biodegradation of manure. It gained use in the nineteenth century when modern wastewater treatment methods were first introduced to clean water for increased use rates as well as enabling sewage disposal and public health improvements. Renewed interest in biodegradation as a means of disposing of petroleum and synthetic based chemicals was first described by Van der Linden in the Netherlands, and developed as applicable soil and water clean up technologies by academic researchers like Richard Bartha of Rutgers University and Martin Alexander of Cornell University. The field of biodegradation is well developed for liquid and gas phase pollutants.

Plastics pose environmental problems both as mechanical and chemical pollutants. Since they are high molecular weight solid materials, they do not dissolve in water, but since they are usually less dense than water, are easily transported by it. They interfere with both physical habitats of fish and chemical environment by releasing plasticizers and other pollutants. Plastic nets continue to kill ocean fish after they are lost to the fisherman and have been the object of international oceanographic and fishing society conventions. Plastics such as PVC are in limited use outside the US because of the hazardous nature of bi-products released into landfills.

Biodegradable plastics already exist in various forms, but so far their mechanical and other properties have limited uses and therefore product demand. This invention is a unique blend of biodegradable nanofiller systems and biodegradable polymers as the material matrix.

The benefits of nanocomposites over their unfilled thermoplastic resin counterparts is well demonstrated even if the field is relatively new and expanding.

Enhancing mechanical resistance especially in the area of storage modulus and for some applications and tensile strength for others, greatly expands the use range of the biodegradable polymers. In addition they can be used to slow down biodegradation rates to allow for medium time use items (1-3 years end-use life for example) The creation of nanocomposites which are biodegradable greatly expands markets and uses of biodegradable plastics.

### OBJECTS OF THE INVENTION

It is an object of the present invention to provide a biodegradable nanocomposite.

It is also an object of the invention to provide a biodegradable nanocomposite made from a blend of a biodegradable polymeric material and a diphosphate treated clay.

It is still another object of the invention to provide biodegradable nanocomposite fillers made from a clay treated diphosphate.

It is a further object of the invention to provide a biodegradable nanocomposite made from a blend of a polymer and a resorcinol diphosphate treated clay.

It is another object of the invention to provide a biodegradable nanocomposite made from a bis-phenol-diphosphate treated clay.

It is a still further object of the invention to provide low cost biodegradable nanocomposites made from nanofiller additives.

It is still another object of the invention to provide nanocomposites where tensile strength can be increased or held at present levels when nanofillers are added.

It is yet another object of the invention to develop both gas permeable and gas impermeable nanocomposites from the use of nanosized fully or partially biodegradable nanofiller additives.

It is still another object is to increase the flexular and storage modulus of the thermoplastic to allow for better load bearing properties.

It is still a further object to decrease the flammability of the biodegradable nanocomposite to expand ranges of use.

It is yet another object of the invention to use the effects of barrier nanofiller additives to greatly enhance gas and water permeability barrier properties.

### SUMMARY OF THE INVENTION

The present invention is directed to blends of diphosphate treated clays mixed with biodegradable polymers. The diphosphates are preferably resorcinol diphosphate (RDP) and bis-phenol diphosphate (BDP) and blends thereof. The biodegradable polymers of the present invention include but are not limited to biodegradable polyalcohols, polyacids, poly-aromatics and esters. Preferred biodegradable thermoplastics are polybeta caprolactame, polybutyrate, biodegradable polyester, and biodegradable cellulosic resins.

In the process of the present invention, the diphosphate is mixed with a clay. Preferred clays are the Wyoming variety of swelling bentonite and similar clays, and hectorite, which is a swelling magnesium-lithium silicate clay, as well as, synthetically prepared smectite-type clays, such as montmorillonite, bentonite, beidelite, hectoritesaponite, and stevensite. The clay could also be an organoclay search as for example cloisite, a clay treated with a quaternary amine.

The diphosphate exfoliates the clay as the clay and diphosphate are mechanically blended. The diphosphate is preferably present in the order of about 0.5 weight percent diphosphate to 75 weight percent diphosphate with the balance clay. A preferred composition has 30 weight percent diphosphate with the remainder clay. Other clays or organoclays can be added to the blends of the present invention, if desired. The diphosphate-clay blend is then mixed with the biodegradable thermoplastic polymer to form a blend that has biodegradable properties. The clay-diphosphate blend is preferably present in an amount of about 0.5 weight percent to 75 weight percent clay disphosphate blend with the balance the biodegradable polymer.

In one embodiment of the present invention, the clay and diphosphate are initially blended together. To the clay blend, one or more biodegradable polymers are subsequently added to the mixture. Alternatively, the diphosphate, clay and biodegradable polymer may all be blended together simultaneously in a single step.

A preferred biodegradable polymer for use in the present invention is cellulose, more preferably nanosized cellulose. The diphosphate and clay blend is mixed with cellulose. The blend of diphosphate, clay and cellulose can be used in, for example, biodegradable thermoplastics.

A preferred cellulose is a cotton ginning lint. Other preferred cellulosic materials are cryometrically nanosized micro dust containing cellulose. In this process, cellulose fibers are frozen to extremely low temperatures such as with the use of liquid nitrogen or solid carbon dioxide. The frozen particles are pulverized to form the microdust of cellulose particles. Another means of making nanosized cellulose particles is through the use of enzymes. In this process, cellulose fiber is mixed with one or more cellulases. The cellulose used in the present invention may also be of microbial origin. Examples of such materials include bacterial, fungul and algael cellulose.

The biodegradable nanocomposites of the present invention have a slower biodegradation rate than corresponding unfilled biodegradable thermoplastic resins which can be of value in certain applications such as computer housings and packaging for multi-year shelf life.

In some applications where it is difficult to blend the biodegradable polymer with the diphosphate clay blend, the diphosphate clay blend can be used as a master batch with another more blendable polymer. This can occur, for example, where an aliphatic polymer is being blended with the diphosphate clay blend. In these instances it may be beneficial to pre-compound the mixture, for example, mix the diphosphate clay blend with a more polar polymer. The blend so formed can then blend with the aliphatic polymer. In one embodiment, a diphosphate clay blend can be blended with a more polar polymer and this preblend can be formed into a resin pellet of the diphosphate clay blend with the polar resin. The pellets so formed are melt blended with the biodegradable polymer. In each instant the blend with the clays should be thoroughly blended together by mechanical means through a mixer or any other suitable device. To the master batch of clay and diphosphate, one or more biodegradable polymers may be added and blended therewith.

In another example, a biodegradable polar polymer such as cellulose is blended with the diphosphate clay mixture. This composition is then dispersed in a biodegradable polymer matrix for use as a pre shear master batch additive for a non-polar biodegradable thermoplastic polymer.

In the compositions of the present invention the gas permeability of the biodegradable polymer is maintained as well as the biodegradation rate of the biodegradable matrix resin. The thermoplastic nanocomposites of the present invention also show clay platelet exfoliation under TEM (transmission electron microscope).

The flexular modulus of the thermoplastic nanocomposites of the present invention also shows an increase disproportional to the loading rate of the biodegradable RDP/BDP treated clay. For example, a 5 weight percent RDP/BDP in a biodegradable composition clay results in 10%±2% increase of the flexular modulus value over the flexular modulus of the unfilled biodegradable thermoplastic resin. Normally the filler to a polymeric material results in a linear increase in flexular modulus. Here the increase is not a linear increase. Rather, a smaller increase in the diphospate clay blend provide greater increases in the flexular modules than would otherwise be expected.

The biodegradable melt blend nanocomposite of the present invention may be extruded, injection molded, blow molded, calendared, or rotationally molded into solid biodegradable nanocomposite products. The resulting biodegradable nanocomposite of the present invention exhibits better flame retardance than the unfilled counterpart resin control in a similar flame, smoke or cone calorimeter test.

### DETAILED DESCRIPTION OF THE INVENTION

The clays used in the present invention are typically a smectite clay. A smectite clay is a natural or synthetic clay mineral selected from the group consisting of hectorite, montmorillonite, bentonite, beidelite, saponite, stevensite and mixtures thereof. A particularly preferred choice for the smectite is montmorillonite.

The present invention includes a method a biodegradable polymeric blend by forming an exfoliated clay by blending a clay with a diphosphate such as resorcinol diphosphate (RDP). The diphosphate coats at least a portion of the surface of the clay platelet, thereby providing improved exfoliation.

Alternatively, the clay platelet may be blended with bisphenol diphosphate (BDP) or a blend of RDP and BDP.

The present invention also includes the composition formed from the blending of one or more biodegradable polyalcohol, a polyacid, a polyaromatic or an ester or blends thereof with clay with either resorcinol diphosphate or bisphenol diphosphate or blends thereof. In a preferred composition, there is an initial blend about 99% to about 50% clay with the balance RDP. Similarly, another preferred composition is 99% to about 50% BDP. In this invention, the RDP or BDP or blends thereof physically coat at least a portion of the clay platelet and allows the clay platelet to exfoliate. While it is possible to have compositions with more than 50% RDP or BDP, in such compositions the RDP and/or BDP acts as a plasticizer which may not always be a desired property for the particular application. Other preferred compositions include blends of 99% to about 80% clay with the balance RDP and/or BDP.

In forming the blends of the present invention, it is preferred that the diphosphate material be heated to about 50° C. to about 100°. The liquid diphosphate can then be sprayed on to the clay. The composition containing the clay and the diphosphate can be mechanically mixed to blend the materials together. Other suitable means of mixing the clay and the diphosphate can be employed. It is also preferred that the diphosphate be heated to a temperature below its vapor point so that the diphosphate material is not vaporized.

Once the clay has been exfoliated by blending with RDP or BDP, the composition can be blended with the biodegradable polymers. In a preferred embodiment, there is about 0.5% to about 75% by weight of the exfoliated clay blend with the balance the biodegradable polymeric material. The present invention may also be used with organoclays as well to enhance their exfoliation. The organoclays can be added to the diposphate clay blends and than the overall blend can be added to the biodegradable polymer.

RDP and BDP are useful as a general dispersant for nanoparticles in a polymer matrix. Both of these diphosphates increase the exfoliation rate of nanoclays or prior organic surface treatments. The diphosphates replace the use of quaternary ammonium salts in organoclays used in nanocomposite polymers in order to achieve exfoliation inside the polymer matrix. The clays useful in the present invention include both natural and synthetic clays. The synthetically prepared smectite clays can include montmorillonite bentonite, beidelite, hectorite, saponite and stevensite clays.

The RDP/BDP blends of the present invention avoid the use of quaternary ammonium salts in organoclays used in nano-composite polymers in order to achieve exfoliation inside the polymer matrix. The clays can include a Wyoming variety of swelling bentonite and similar clays, and hectorite, which is a swelling magnesium-lithium silicate clay, as well as, synthetically prepared smectite-type clays, such as montmorillonite, bentonite, beidelite, hectoritesaponite, and stevensite.

In the present invention, blends of diphosphate treated clays are mixed with biodegradable polymers.

The diphosphates are preferably resorcinol diphosphate (RDP) and bis-phenol diphosphate (BDP) and blends thereof. The biodegradable polymers of the present invention include but are not limited to biodegradable polyalcohols, polyacids, poly-aromatics and esters. Preferred biodegradable thermoplastics are polybeta caprolactame, polybutyrate, biodegradable polyester, and biodegradable cellulosic resins.

The diphosphate exfoliates the clay as the clay and diphosphate are mechanically blended. The diphosphate is preferably present in the order of about 0.5 weight percent diphosphate to 75 weight percent diphosphate with the balance clay. A preferred composition has 30 weight percent diphosphate with the remainder clay. Other clays or organoclays can be added to the blends of the present invention, if desired. The diphosphate-clay blend is then mixed with the biodegradable thermoplastic polymer to form a blend that has biodegradable properties. The clay-diphosphate blend is preferably present in an amount of about 0.5 weight percent to 75 weight percent clay disphosphate blend with the balance the biodegradable polymer.

A preferred cellulose is a cotton ginning lint. Other preferred cellulosic materials are cryometrically nanosized micro dust containing cellulose. In this process, cellulose fibers are frozen to extremely low temperatures such as with the use of liquid nitrogen or solid carbon dioxide. The frozen particles are pulverized to form the microdust of cellulose particles. Another means of making nanosized cellulose particles is through the use of enzymes. In this process, cellulose fiber is mixed with one or more cellulases. The cellulose used in the present invention may also be of microbial origin. Examples of such materials include bacterial, fungul and algael cellulose.

1. A biodegradable composition comprising an exfoliated clay, a diphosphate and a biodegradable polymer said clay being exfoliated by said diphosphate.

2. The composition of claim 1 wherein the diphosphate is resorcinol diphosphate.

3. The composition of claim 1 wherein the diphosphate is bisphenol diphosphate.

4. The composition according to claim 2 wherein the biodegradable polymer is a blend of one or more biodegradable polymers selected from the group consisting essentially of esters, polyalcohols, polyacids and polyaromatics.

5. The composition according to claim 4 wherein at least one biodegradable polymer is an ester.

6. The composition according to claim 4 wherein at least one biodegradable polymer is a polyalcohol.

7. The composition according to claim 4 wherein at least one biodegradable polymer is a polyacid.

8. The composition according to claim 4 wherein at least one biodegradable polymer is a polyaromatic.

9. The composition according to claim 4 wherein at least one biodegradable polymer is cellulose.

10. The composition according to claim 9 wherein the cellulose is nanosized cellulose.

11. The composition according to claim 9 wherein the cellulose is a cotton ginning lint.

12. The composition according to claim 9 wherein the cellulose is a cryometrically nanosized micro dust containing cellulose.

13. The composition according to claim 9 wherein the cellulose is mixed with one or more cellulases.

14. The composition according to claim 9 wherein the cellulose is of micróbial origin.

15. The composition according to claims 4 wherein said biodegradable polymer is a poly beta caprolactam.

16. The composition according to claims 4 wherein the biodegradable polymer is a poly butyrate.

17. The composition according to claim 4 wherein said composition further comprises an organoclay.

18. The composition according to claim 3 wherein the biodegradable polymer is a blend of one or more biodegradable polymers selected from the group consisting essentially of esters, polyalcohols, polyacids and polyaromatics.

19. The composition according to claim 18 wherein at least one biodegradable polymer is an ester.

20. The composition according to claim 18 wherein at least one biodegradable polymer is a polyalcohols.

21. The composition according to claim 18 wherein at least one biodegradable polymer is a polyacid.

22. The composition according to claim 18 wherein at least one biodegradable polymer is a polyaromatic.

23. The composition according to claim 18 wherein at least one biodegradable polymer is cellulose.

24. The composition according to claim 23 wherein the cellulose is nanosized cellulose.

25. The composition according to claim 23 wherein the cellulose is a cotton ginning lint.

26. The composition according to claim 23 wherein the cellulose is a cryometrically nanosized micro dust containing cellulose.

27. The composition according to claim 23 wherein the cellulose is mixed with one or more cellulases.

28. The composition according to claim 23 wherein the cellulose is of microbial origin.

29. The composition according to claim 18 wherein said biodegradable polymer is a poly beta caprolactam.

30. The composition according to claim 18 wherein the biodegradable polymer is a poly butyrate.

31. The composition according to claim 4 wherein said composition further comprises an organoclay.

32. A method of forming a biodegradable composition comprising forming a mixture of a clay and a diphosphate said diphosphate exfoliating said clay, adding said mixture to a biodegradable polymer to form a biodegradable mixture.

33. (canceled)

34. The method according to claim 33 wherein said diphosphate is resorcinol diphosphate.

35. The method according to claim 33 wherein said diphosphate is bisphenol diphosphate.

36. The biodegradable composition according to claim 1 wherein the diphosphate is heated to from about 50° C. to about 100° C.

37. The biodegradable composition according to claim 32 wherein the diphosphate is heated to from about 50° C. to about 100° C.

38. The biodegradable composition according to claim 32 wherein the diphospate is heated to a temperature below its vapor point prior to mixing with the clay.

39. The method according to claim 32 wherein disphosphate is sprayed onto the clay.
